(19) United States
(12) Patent Application Publication
(10) Pub. No.: US 2004/0168992 A1
(43) Pub. Date: Sep. 2, 2004

(54) Device, system and method for gray water recycling

(76) Inventor: Ori Ben-Amotz, Caesarea (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/734,119

(22) Filed: Dec. 15, 2003

(30) Foreign Application Priority Data
Feb. 27, 2003 (IL) 154644

(51) Int. Cl. B01D 29/00

(52) U.S. Cl. 210/805; 210/167; 210/416.1

(57) ABSTRACT

A water recycling solution for gray water is provided, which may include upper and lower water tanks placed at high and low points, respectively, of for example a building or residence. Piping and valves (which may be low pressure) may be incorporated to enable efficient low-pressure water flow throughout the system. Mechanical filters and/or traps, colorants and anti-bacterial chemicals etc. may be utilized to, for example, prevent clogging and reduce contaminants within the gray water utilized.

### CROSS REFERENCE TO RELATED APPLICATIONS

This application claims priority from Israeli Patent Application No. 154644, filed Feb. 27, 2003, entitled “GRAY WATER RECYCLING SYSTEM”, which is incorporated in its entirety herein by reference.

### FIELD OF THE INVENTION

The present invention relates generally to the field of water recycling, and more particularly to a low pressure recycling system and method for recycling water from selected gray water sources.

### BACKGROUND OF THE INVENTION

Water saving methods generally focus on reducing usage of fresh water supplies. It has been estimated that the flushing of toilets (one way of creating black water) constitutes between 38 to 45% of all interior domestic water usage (fresh water) in the USA and 40% in Israel. That is, nearly half the fresh water usage in the US which turns fresh water into black water is accounted for by flushing toilets.

Gray water may be defined as water that contains some level of impurity generally lower than that of black water. For example, gray water may come from sinks, showers, bathtubs, laundry, etc. It is estimated that between 42% and 79% of gray water comes from bathtubs and showers, and 5% to 23% from laundry facilities (The Humanure Handbook. Jenkins Publishing, PO Box 607, Grove City, Pa. 16127, see chapter 9). Many attempts have been made, over the last few decades, to provide solutions to reduce fresh water usage by flushing toilets, laundry facilities and bathtubs.

Water saving attempts can generally be put into three categories: water collecting, water usage reduction, and water re-cycling. Although there have been numerous improvements in all three categories, and despite the fact that water saving measures have been mandated through legislation in various countries, a lack of fresh water in large portions of the world is still a major problem. There is a constant need for additional improvements in the way that human communities utilize their fresh water supplies.

Some water-recycling measures have included enabling irrigation of home gardens using gray water, which may be defined as non-toilet wastewater produced in a household including the water from bathtubs, showers, sinks, washing machines, and dishwashers. Treated sewage (e.g., toilet) water may also be defined as gray water. Gray water usage has typically been implemented by collecting such water in buckets or alternative water collection reservoirs, and transferring the water to a final destination via channels that are not used for fresh water.

More recent methods of water conservation have been implemented using water purification systems, which provide complete water treatment of grey and black water, including the water coming from the toilets. These methods, however, are very expensive, complex to implement and maintain, and require the usage and storage of hazardous chemicals.

Attempts to implement gray water solutions have not been successful in penetrating the mass market. Some of the obstacles to the adoption of gray water saving systems have included: (1) prohibitive costs in setting up these systems, (2) bad odors or fumes from the water, (3) low water pressure, (4) contamination of the places being irrigated and of fresh water sources due to bacteria associated with still gray water, (5) drainage problems and (6) issues such as preventing the consumption of such recycled water.

It would be highly advantageous to have a system and method that enables effective, aesthetic, and easy to implement gray water recycling system.

### SUMMARY OF THE INVENTION

According to some embodiments of the present invention, there is provided a water recycling solution for gray water. According to some embodiments of the present invention, upper and lower water tanks may be placed at high and low points, respectively, of a building or residence. Low-pressure piping and valves may be incorporated to enable efficient low-pressure water flow throughout the system. In addition, according to some embodiments of the present invention, mechanical filters and/or traps may be utilized to prevent clogging and reduce contaminants and odors within the gray water utilized.

As part of a gray water recycling system according to some embodiments of the present invention, there may be a separation between a building's or residence's gray water flushing system and its existing fresh water plumbing system. Gray water sources may be selected by the user, such that the gray water from selected sources, being relatively “clean” gray water, freely flows to a collection point, is pumped to an expansion tank, and flows into toilet flush tanks or other water targets upon demand. Gray water may flow from a collection point, which is at a relatively high point, to gray water targets, at relatively lower points, using gravity.

There may be provided, in accordance with at least one embodiment of the present invention, a fresh water backup system for ensuring constant water flow into the system. The fresh water backup system may be provided with a one-way valve and/or a valve with an “Air Gap” to prevent contact of gray water with the fresh water source.

There may be provided, in accordance with at least one embodiment of the present invention, a system and method for adding colorants, detergents, decontaminants, purifiers, vapors, and any other additives to the gray water, for further improving the gray water quality, and/or differentiating the gray water from other water supplies.

There may also be provided, in accordance with at least one embodiment of the present invention, a means for selecting or determining s particular water targets in a domestic plumbing system.

There may also be provided, in accordance with at least one embodiment of the present invention, a means for eliminating the hot-water surge phenomenon, by extracting the flush toilets from the remainder of the building plumbing system.

There may further be provided, in accordance with at least one embodiment of the present invention, a means for limiting damages, for example, flooding damage, that may be caused by high-pressure pipes that connect to toilets in typical plumbing systems, by installing low-pressure pipes and valves in the toilet plumbing system.

According to some embodiments of the present invention a gray water recycling system may include a lower tank for collecting gray water from at least one selected gray water source, the lower tank being placed at a lower altitude than the selected gray water source; an upper tank placed at a higher altitude than at least one water target connected to the system; a pump to pump collected gray water in the lower tank to the upper tank; and piping connecting the upper tank to at least one water target. At least one non-return valve may be used to prevent the gray water in the upper tank from returning to the gray water in the lower tank. A low pressure supply valve may be provided to connect piping from the upper tank to at least one water target, such that water pressure in the piping and in the supply valve is substantially unchanged. At least one dispenser may be provided for dispensing at least one additive into collected gray water. At least one filtering mechanism, for example, a filter or trap may be used. The filtering mechanism may filter collected gray water at at least one location including, upon entering into said lower tank, upon being transferred from said lower tank to said upper tank, and upon being transferred from said upper tank to said water target. At least one overflow outlet may be provided for discharging and/or distributing excess gray water from the lower tank. At least one overflow outlet may be provided for discharging and/or distributing excess gray water from the upper tank. At least one drain valve may be provided for discharging excess content from the lower tank. At least one drain valve may be provided for discharging excess content from the upper tank.

According to one embodiment of the present invention, a water backup mechanism, which may include a fresh water inlet into the upper tank, may be provided for ensuring constant flow of water into the system. The water backup mechanism may include a valve in the fresh water inlet for preventing contact between collected gray water and the fresh water inlet. The water backup mechanism may include a shut-off valve and float for determining when at least a minimum water level has been reached in the upper tank. The water backup mechanism may initiate a fresh water flow into the upper tank when a selected water level has been reached in the upper tank. The water backup mechanism may close off the fresh water flow when at least a minimum water level has been reached in the upper tank. A shut-off valve may be provided to close off a flow of water from the upper tank to at least one water target. The water target may include a flush tank, garden, field, drainage system, cleaning apparatus, and black water apparatus.

According to some embodiments of the present invention, method for recycling gray water may include collecting gray water from at least one selected source in a lower tank, the lower tank being situated at an altitude lower than at least one selected source; transferring gray water collected in the lower tank to at least one upper tank connected to the lower tank, the upper tank connected to at least one water target, the upper tank being situated at an altitude higher than at least one water target; and when the water target requires a water supply, releasing gray water from the upper tank to at least one water target. At least one additive may be dispensed to the collected gray water. Water may be discharged from the lower tank. Excess water may be discharged from the upper tank. At least one filtering mechanism may filter gray water at one or more stages of the method, for example, before the water is transferred into said upper tank, and/or before being discharged from the upper tank. At least one additional water inlet may be provided for the upper tank. A valve may be placed in the additional water inlet to prevent contact of collected gray water in the upper tank with a fresh water source. At least one water target may be connected to the upper tank using piping and at least one low-pressure supply valve. A shut-off valve may be connected to the piping, to shut off the upper tank from at least one water target.

According to some embodiments of the present invention, a low pressure plumbing system may include an inlet pipe to transfer water from a gray water collection tank into a flush tank; a low pressure valve with substantially similar internal thickness as said inlet pipe, the valve being connected between the inlet pipe and the flush tank; and at least one connector, with substantially similar internal thickness as the low pressure valve, to connect the low pressure valve to a filler tube in the flush tank.

According to some embodiments of the present invention, a method for recycling gray water may include collecting gray water from at least one selected gray water source in a lower tank, the lower tank being situated at an altitude lower than at least one gray water source; pumping collected gray water from the lower tank to an upper tank, the upper tank being situated at an altitude higher than at least one water target; and when at least one water target requires a water supply, releasing gray water from the upper tank to at least one water target. Fresh water may be added to the upper tank from a fresh water inlet, when gray water level in the upper tank is below a determined level. The water source may include washing machines, basins, sinks, showers, bathtubs and air conditioning units. The water targets may include flush tanks, gardens, fields, drainage systems, cleaning apparatus, and black water apparatus.

### BRIEF DESCRIPTION OF THE DRAWINGS

Embodiments of the present invention will be understood and appreciated more fully from the following detailed description taken in conjunction with the appended drawings, it being understood that these drawings are given for illustrative purposes only and are not meant to be limiting, in which:

FIG. 1 is a diagram illustrating the components of a gray water recycling system, according to at least one embodiment of the present invention;

FIG. 2 is a diagram illustrating the components of a lower tank according to at least one embodiment of the present invention;

FIG. 3 is a diagram illustrating the components of an upper tank according to at least one embodiment of the present invention;

FIG. 4 is a diagram illustrating flush tank components according to at least one embodiment of the present invention; and

FIG. 5 is a diagram that illustrates a method performed according to at least one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

In the following detailed description, numerous specific details are set forth in order to provide a thorough understanding of the present invention. However, it will be understood by those skilled in the art that embodiments of the present invention may be practiced without these specific details. In other instances, well-known methods, procedures and components have not been described in detail so as not to obscure the present invention.

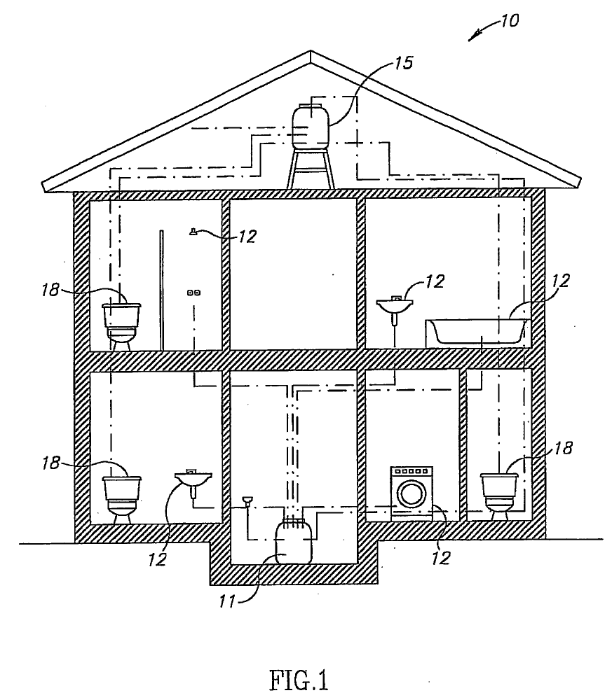

Specifically, reference is now made to FIG. 1, which is an illustration of the components of the water recycling system according to some embodiments of the present invention, as viewed according to a typical implementation in a home or building. An implementation of a water recycling system according various embodiments of the present invention may be executed in any apartment, house, commercial unit, hotel, office block, community facility or any other building with a plumbing system, hereinafter referred to as “building” 10. A lower tank, hereinafter referred to as a collection tank 11 may be placed located below the lowest level (e.g., altitude) of habitable or otherwise usable space, thereby being below the level of the gray water source, such that water from at least one selected gray-water source 12 may flow by gravity to the collection tank 11. A gray water source may be defined as any water using appliance or facility that provides gray water. Gray water may be defined as substantially unpolluted water, including but not limited to water from baths, showers, wash basins, sinks, washing machines and from other suitable sources. An expansion tank 15 may be placed at, for example, the highest utilized (e.g., for water usage purposes) level of the building 10, and water that has been collected from the collection tank 11 may be transferred, for example pumped, to expansion tank 15. Water in expansion tank 15 may subsequently flow by the force of gravity to the toilet 18 or alternative recycled water destination. Other suitable levels or locations for the positioning of the various components discussed herein may be used. The size of the tanks may be designed such that a water or sump pump, located either in the collection tank 11 or external to the collection tank 11 reaches a low point of the collection tank 11, thereby ensuring that water above a low water point in the tank may be pumped to the expansion tank when the pump is activated. The expansion tank 15 capacity may typically be designed to provide approximately a half of one day's water usage, or any other suitable capacity, for the building 10 being fitted with the system. These tank sizes may provide high water circulation from both tanks, such that the gray water need not stay much longer than a day, or any other determined time limit, in the system. In addition, in some embodiments, in the case where a user is expecting to be away from the building 10 for some time, and does not want the gray water to sit for all this time, the user may open the drain valve, thereby enabling the gray water and contents at the lowest level of the tank to be drained from tank 11. This lowest level in the tank is typically filled, in addition to gray water, with debris such as lint, hair, debris, mud, slush, mire, muck, slime, sludge and the like to the gray water may be routed to a sewer instead of the collection tank 11, by turning, for example, a three-way diverter valve, which may be located before the collection tank, for maintenance, cleaning and/or disconnecting the system.

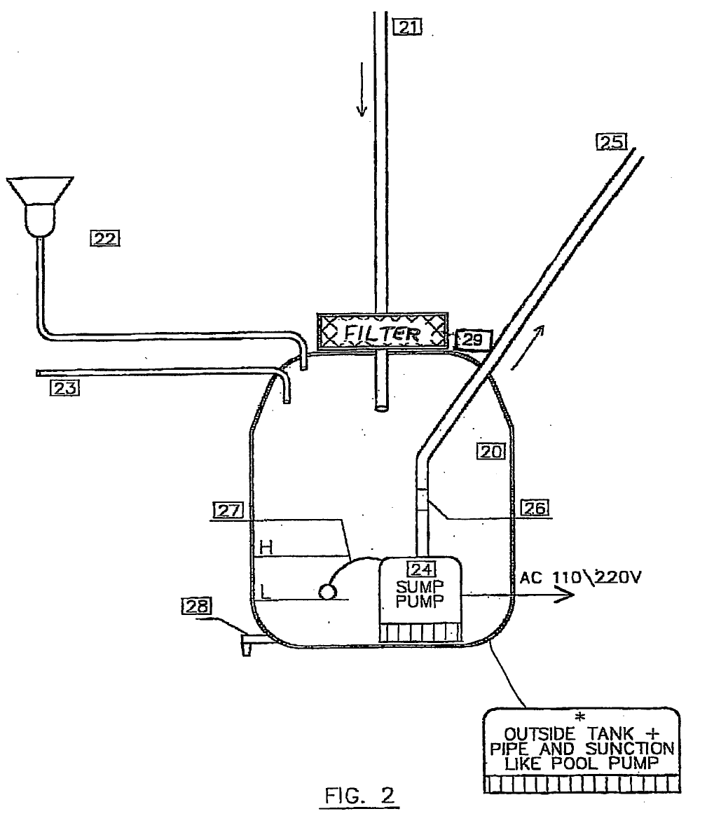

The components of the collection tank 11 according to one embodiment may be seen with reference to FIG. 2, which illustrates the collection tank 20 according to at least one embodiment of the present invention. A pipe (e.g., incoming pipe) 21 may be set up to transport gray water from a selected gray-water source to the collection tank 20, using for example the force of gravity. A one-way, backflow, or other suitable valve may be connected to the collection tank to prevent potential flow of gray water back to the building. A supply or dispenser 22 may be connected to the collection tank 20 to enable adding of elements to the water for the purposes of for example disinfecting, decontaminating, chlorinating, providing pleasant smells, pleasant aesthetics, water safety standards etc. For example, a coloring agent may be inserted into the water to provide pleasant smells, to disinfect the water and/or to color for the water etc. An additional benefit of such colored water may be to enable user differentiation of recycled water, thereby minimizing the risks of user's or animals drinking non-drinkable gray water. An overflow outlet 23 may be integrated into the collection tank 20, for enabling excess water to flow out of the collection tank 20 when required. This overflow outlet 23 may be used to transport excess gray water to the black water system, or to alternative water targets, such as a garden, a watering system, etc. A water target may be, for example, a water usage device or system that may accept a certain type of water, such as gray water. For example, a gray water target, depending on the user and usage requirements, may be, for example, a toilet tank, a garden, a watering system, an outside cleaning system (e.g., a hose for cleaning a sidewalk), a fire extinguishing system, etc. A water pump or sump pump 24, which may be for example mechanical or electrical, may be provided to pump up the collected gray water from the collection tank 20 to the expansion tank 15. The water pump 24 may be placed inside the collection tank 20, as can be seen in FIG. 2, or external (not seen in Figure) to the collection tank 20. External pumps may typically be used for higher capacity pumps, such as tanks designed for larger and/or higher buildings. In the case where the pump 24 is external to the collection tank 20, a pipe is provided through which water may be drawn from the collection tank 20 to the pump 24. A pipe (e.g., outgoing pipe) 25 may be fitted to the pump 24, for transporting the gray water being pumped up to the expansion tank 15. A one-way or non-return valve 26 may be placed in the outgoing pipe 25, thereby preventing the return of water from the expansion tank 15 or outgoing pipe 25 to the collection tank 20. A water level sensor is provided, connected by a mechanical indicator 27 to the pump 24, such that when the indicator 27 reaches a determined “high” level (H) of water in the tank 20, the pump 24 may be triggered and the water may be pumped to the expansion tank, until the low water level (L) is reached inside the collection tank 20. A low level of water may be maintained in the tank 20 as larger debris and other unwanted elements in the gray water will generally be found in the lower levels of the water, such as the level represented by the low level of the water level sensor. In this way, the unwanted larger particles in the gray water will not be pumped into the expansion tank. In addition, the pump may require a minimum level of water in the collection tank 20 so as not to draw in air and be at greater risk of motor burn out. A drain valve 28 may be provided at the lower portion of the collection tank 20, for enabling the release of the lowest or bottom supply fresh water to the expansion tank 30, when needed. For example, if there is an inflated demand on the gray water supply within the expansion tank 30, fresh water supplies may be tapped to supplement the water quantity in the expansion tank 30. A non-return valve 33 and/or a valve with an “Air Gap” may be placed in pipe 32 of the water backup mechanism, for preventing contact of gray water with the fresh water pipe 33 and/or to a fresh water source that supplies fresh water to the fresh water pipe 33.

An “Air Gap” valve may be, for example, a valve that provides an air gap between fresh water inlet 32 and shut off valve and float 34, to prevent contact of the fresh water and the tank contents to be in contact with each other. For example, a pipe, referred to herein as a gap-pipe may be attached to the bottom of expansion tank 30, which may enable entry of gray water inside the tank, to help measure the gray water level in the tank. The gap-pipe may be connected to shut-off valve and float 34, such that the float 34 may float on the surface of the water level as indicated by the water level in the gap-pipe. A rod, for example, a stainless steel rod, may be attached from fresh water inlet 32 to the float, such that when the float reaches a determined level the fresh water inlet pipe 32 is closed. According to an embodiment, the fresh water inlet may be located above the water overflow outlet 31, and/or above the maximum water level 35, such that there is a minimal gap (e.g., 2 cm) between the highest potential gray water level and the fresh water inlet 32. Other mechanisms may be used to prevent contact of gray water with a fresh water source, for example, an electro optic sensor and/or a pressure sensor to detect the water level in the gray water tank, and close the fresh water inlet pipe before the gray water source reaches the input pipe level. A shut-off valve and float 34 may be provided in the expansion tank 30, to measure the water level in the expansion tank 30, and control the flow of fresh water from the fresh water inlet 32. In this way, if the water level is below a predetermined level (e.g., the minimum water level 35), fresh water inlet 32 may be opened, and fresh water may flow into the tank from the fresh water pipe 33. When the water level is at or above a determined water level (e.g., the minimum water level 35), the float 34 may close the fresh water inlet 32 and no level of the collected water, which typically contains the larger particles and unwanted elements in the collected gray water, including lint, hair, debris, mud, slush, mire, muck, slime, sludge and the like. A filtering mechanism, for example, a mechanical filter 29 and/or trap may be fitted to the incoming water pipe 21 and/or the outgoing water pipe 25, to filter out or otherwise withhold unwanted elements from the gray water. A vent pipe, for example to enable escape of air, may be fitted to collection tank 11.

According to some embodiments of the present invention, relatively thick pipes (e.g., two inch pipes etc.) may be used for the incoming 21 and outgoing 25 pipes. Relatively medium thickness pipes (e.g., one-inch pipes etc.) may be used for the dispenser 22 and overflow outlet 23 pipes. It should be noted that the various sizes, capacities and/or strengths of the various components in the water recycling system, including the tanks, pipes, pump, valves, dispenser, filters etc., may be integrated into embodiments of the present invention, according to the system requirements, and typically as a function of supply and demand for gray water in the building 10. These various possible configurations of the various components may be changed according to the needs and designs of a particular gray water recycling system being implemented.

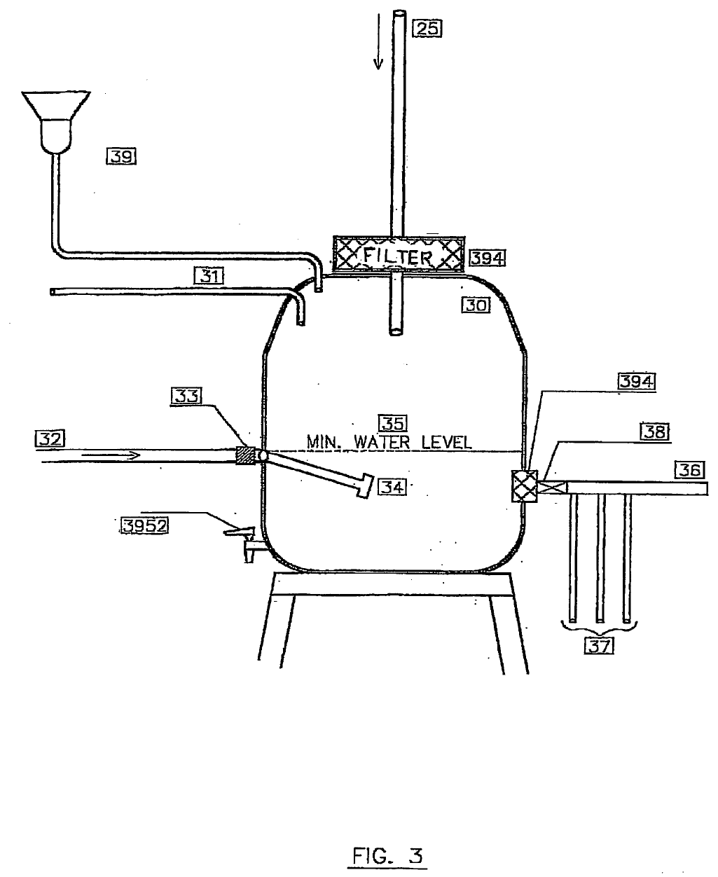

The components of the expansion tank 15 can be seen with reference to FIG. 3, which illustrates the expansion tank 30 according to at least one embodiment of the present invention. The outgoing pipe 25 from the collection tank 20 enters into the expansion tank 30. A filtering mechanism, for example, a filter or trap 394 for filtering out or otherwise withholding larger particles from the gray water, may be connected to outgoing pipe 25. An overflow outlet pipe 31 may be placed in the upper area of the expansion tank 30, for enabling excess water to flow out of the expansion tank, when a determined water level has been reached, or when otherwise necessary. This overflow outlet 31 may be used to transport excess gray water to the black water system or to alternative water targets, such as gardens or for cleaning purposes. According to some embodiments of the present invention a water back up mechanism may be provided, for example, an additional pipe or inlet 32 may be used to more fresh water may flow into the tank 30. At least one outgoing pipe 36 may be attached to the expansion tank 30, for transporting gray water to determined water targets (e.g., flush toilets 18 etc.). In the case where a plurality of water targets are set up to receive gray water, each water target may be connected by a pipe 37 to the outgoing pipe 36. A shut-off valve 38 may be added to the outgoing pipe 36, to turn off the water supply from the expansion tank 30 to the water targets. A dispenser 39 may be connected to the expansion tank 30 to enable adding of elements to the gray water in the expansion tank 30 for the purposes of disinfecting, decontaminating, providing pleasant smells, pleasant aesthetics, water safety standards etc. A drain valve 392 may be provided at a lower portion of the expansion tank 30, for enabling the release of the collected water and debris etc. found in the lower reaches of the tank 30. A mechanical filter 394 and/or trap may be fitted to the outgoing water pipe 36, to filter out or otherwise withhold unwanted elements from the gray water, such as hair, lint, debris and the like. A vent pipe may be fitted to expansion tank 30.

According to some embodiments of the present invention, large pipes (e.g., two inch pipes etc.) may be used for the incoming 25 and outgoing 36 pipes as well as the fresh water pipe 33. Medium thickness pipes (e.g., one-inch pipes etc.) may be used for the dispenser 39 and overflow outlet 31 pipes. Slightly narrower pipes (e.g., ¾ Inch pipes etc.) may be used for the pipes 37 connecting the outgoing pipe 36 to the water targets. It should be noted that the various sizes, capacities and/or strengths of the various components in the water recycling system, including the tanks, pipes, pump, valves, dispenser, filters etc., according to some embodiments of the present invention, may be integrated into the system, according to the system requirements, and typically as a function of supply and demand for gray water in the building 10. These various possible configurations of the various components may be changed according to the needs and designs of a particular gray water recycling system being implemented.

Typical pipes that are configured for each water target (e.g., a flush tank toilet etc.) are approximately ⅜-½ inch pipes. These pipes are designed to supply gray water from the expansion tank to the water targets at low pressure, where they typically flow into significantly smaller pipes and valves, increasing the water pressure as the water is forced through these small channels into the flush tank. In the case where the gray water recycling system, according to at least one embodiment of the present invention, recycles gray water for use in flush toilets, the gray water remains at low pressure even when entering into the flush tank, using widened pipes and valves that may be designed to substantially similar specifications as the incoming pipes.

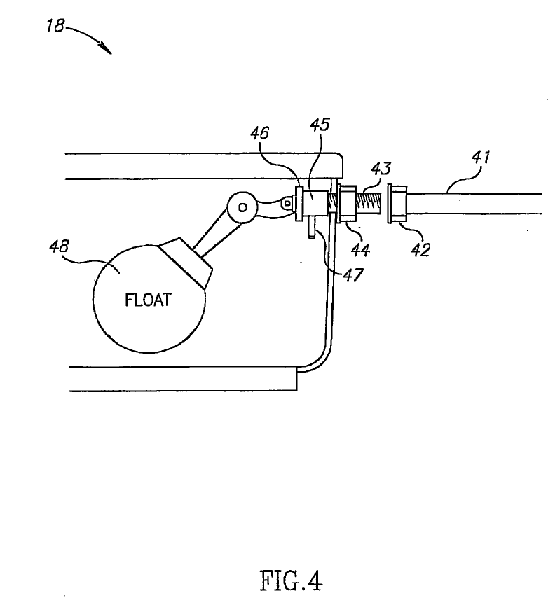

FIG. 4 illustrates at least one embodiment of piping, connectors and valves at the entry point of the flush tank, hereinafter referred to as the “supply valve”. Each of the elements that provide the connection between the inlet pipe 41 and the flush tank, and in particular the connection to the flush tank water outlet 47 are characterized in having substantially similar internal thicknesses to the pipes which bring the gray water into the flush toilets or alternative water targets. These low-pressure components thereby enable the water to flow into the flush tank 40 at low pressure, but at a substantial rate. In this way, the gray water from the expansion tank 30 may flow under the force of gravity into the flush tank 40, without being restricted to the typical high-pressure valves entering such tanks. Such gravity enabled water flow may enable rapid, and relatively silent, flush tank filling, causing fewer incidences of water pressure damage to the piping apparatus and helping avoid clogging of the valves. The filling of such a tank may typically be completed, for example, within 1-2 minutes, depending on various factors, such as the height of expansion tank 30 above flush tank 40.

According to an embodiment, for example, a pipe 41 (e.g., a ½ inch pipe etc.) may transport water from the expansion tank 30 to the flush tank 40. A low pressure valve, with a substantially similar thickness to pipe 41, may be placed within a valve housing 45, which may connect the inlet pipe 41 to the flush tank float 48 using low pressure connectors 44, 46. These low-pressure connectors may have a substantially similar thickness to inlet pipe 41. This low-pressure piping apparatus, which may include at least the inlet pipe, connectors, valve etc. may enable water to flow at a substantially constant pressure or rate from an upper collection tank through to a selected water target, such as a flush tank etc.

It should be noted that the various sizes, capacities and/or strengths of the various components in the water recycling system, including the tanks, pipes, pump, valves, dispenser, filters etc., according to some embodiments of the present invention, may be determined according to the supply and demand for gray water in the building 10. These various possible configurations of the various components may be changed according to the needs and designs of a particular gray water recycling system being implemented.

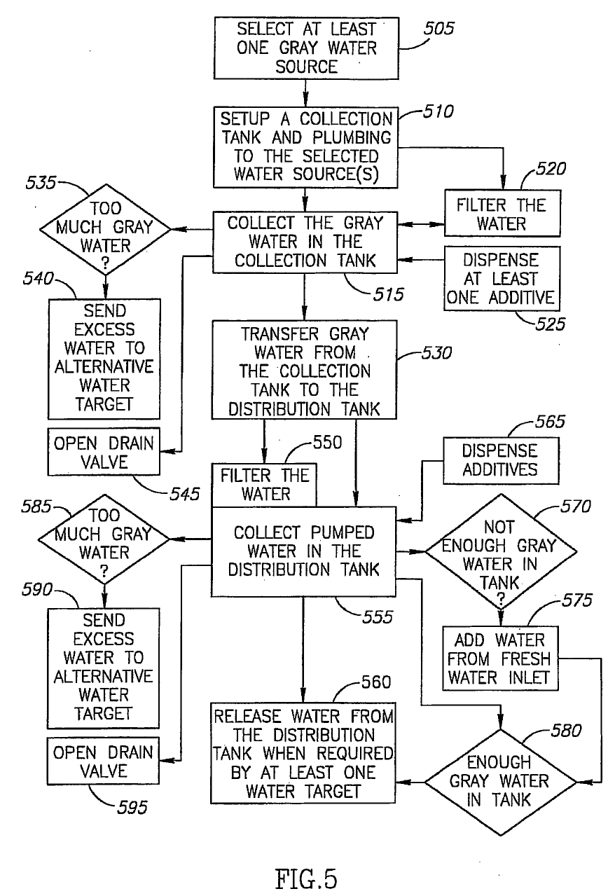

FIG. 5 is a flowchart that illustrates an example of how the system typically operates, according to one embodiment of the present invention. At block 505 gray water sources may be selected by a user. At block 510 selected sources for recycling may be pre-plumbed and/or retrofitted in existing buildings, to provide a flow of water, using gravity, into the Collection Tank 20. Rain catchments may also feed into the system, entering into either of the tanks through at least one determined point. At block 515, after setting up the collection tank 20 and relevant plumbing, the gray water from the selected source(s) 12 may flow into the collection tank 20. At block 520 the incoming water may pass through a mechanical filter 29 and/or trap, for example, before entering the collection tank 20, thereby being filtered. At block 525 an additive, such as a pleasant smelling Blue Coloring agent may be added to the water, by for example a Dispenser 22 or at flush tank 40. At block 530 water from collection tank 20 may be transferred to expansion tank 30, for example, when the water reaches a determined high point in the tank, as detected by the water level sensor 27, a pump 24 may be activated to pump the water upward to the Expansion Tank 30. At block 535, in the case where too much gray water is in the collection tank 20, for any reason or because of any technical problem, excess water may be transferred, at block 540, to an alternative water target via the overflow outlet 23. Alternatively, at block 545, water (e.g., together with lint, hair, debris, mud, slush, mire, muck, slime, sludge and the like) may be released from the collection tank using the drain valve 28.

At block 550 the water may flow through a filter or trap before entering the expansion tank 30. At block 555 when the water reaches the Expansion Tank 30, it may be stored in the tank 30 until at least one of the water targets 18 are at least partially emptied, at which time water may be released, at block 560, from the expansion tank 30 to the emptied or partially emptied water target(s) 18 using the force of gravity.

At block 565 additives may be dispensed into the water in the tank 30. At block 570, in the case where there is not enough gray water in the tank 30, as determined by the shut-off valve and float 34, such as in the case where the demand for the water is greater than the supply, the fresh water inlet may be opened to enable, at block 575, the adding of fresh water into the expansion tank, until at least the minimum level 35 is reached.

At block 585, in the case where too much gray water is in the collection tank 30, for any reason or because of any technical problem, excess water may be transferred to an alternative water target, at block 590, via the overflow outlet 23. At any time, water (e.g., together with lint, hair, debris, mud, slush, mire, muck, slime, sludge and the like) may also be released, at block 595, from the collection tank using the drain valve 28.

At the connection point, referred to herein as supply valves, for each water target 18, such as flush tanks, low pressure valves 42, valve housing 45 and connectors 44, 46 (e.g., with an internal diameter of 5 to 7 millimeters), are fitted that allow the water to flow to the Flush Tank 40 without a reduction in the pipe size (e.g., ⅜″ or ½″ etc., depending on the type of Flush Tank type; other suitable sizes may be used). Incoming gray water may pass through this flush tank entry point and may enter the flush tank 40 through the low-pressure water outlet 47, at low-pressure and by force of gravity. This low-pressure high performance water flow prevents may clogging of the various pipes leading into the flush tank 40, by threads, hair, detergents and the like (e.g., due to the wide piping etc.), and may enable fast filling of flush tanks and the like. The float mechanism 48 may be substantially similar to the currently used flush toilet floats; other suitable floats may be used. All the pipes from the Expansion Tank 30 to the Flush Tank 40, as well as all the water targets 18 in the recycling system, may be filled with the Gray Water at any time and may be ready for use.

In the case where the demand is greater than the supply of Gray Water from the expansion tank 30, the level of the water in the Expansion Tank 30 may drop under a minimal level defined 35. At this point, the shut-off valve and float 34 may be in a low position relative to the inlet 32, thereby opening up the fresh water inlet 32. Fresh water is thereby enabled to flow into the expansion tank 30, from a fresh water source, until a determined, or minimum water level 35 has been reached. At this minimum water level 35 the shut-off valve and float 34 may be positioned in a flat position relative to the inlet 32, thereby closing off the fresh water inlet 32 and shutting off the incoming fresh water supply. The fresh water inlet 32 provides a back-up mechanism for the recycling system, and provides a way to ensure a continual supply of water for the water targets. The fresh water inlet 32 may also enable continual usage of the water recycling system with fresh water only, without any Gray Water (e.g., in the case where the user disconnects the gray water supply or the pump etc.), if desired at any time for whatever reason.

In the case of greater supply of than demand for gray water, or technical problems such as a pump problem or a power problem, where the water level in either the collection 20 or the expansion 30 tank rises above a determined high level, the excess water may exit either or both of the tanks through the overflow pipes 23, 31. From the overflow pipes 23, 31 the water may irrigate the garden, be spilled into the sewage system, or be directed to any alternative destination.

There is also provided, in accordance with at least one embodiment of the present invention, a means for eliminating a hot-water surge phenomenon wherein a user of a shower or bath may experience a hot water gush when another person flushes a connected toilet. This may be caused by the high-pressure water requirement for the cold water to refill the flush tank, leaving the shower or bath with relatively little cold water, and therefore a substantially hotter temperature of the running water. By extracting the flush toilets from the remainder of the building plumbing system, according to embodiments of the present invention, the above-described elimination of the hot surge phenomenon may be prevented.

There is also provided, in accordance with at least one embodiment of the present invention, a means for limiting the damages, for example, flooding damage, that may be caused by high-pressure pipes that connect to toilets in typical plumbing systems, by installing low-pressure pipes and valves in the toilet plumbing system. The high-pressure rush of water that typically refills flush tanks after flushing often causes harm to the hoses, valves, floats and pipes. According to some embodiments of the present invention, the low-pressure water flow into the flush tanks, enabled by the piping and valves designed for low-pressure flow, may prevent many of these damages from occurring.

The foregoing description of the embodiments of the invention has been presented for the purposes of illustration and description. It will be appreciated that embodiments of the present invention are not limited by what has been described hereinabove and that numerous modifications, all of which fall within the scope of the present invention, exist. For example, while embodiments of the present invention have been described with respect to a single building, the scope of the present invention includes the setting up of a system for a compound of buildings.

It will be appreciated by persons skilled in the art that the present invention is not limited by what has been particularly shown and described herein above. Rather the scope of the invention is defined by the claims that follow:

What is claimed is:

1. A gray water recycling system comprising:
a lower tank for collecting gray water from at least one selected gray water source, said lower tank being placed at a lower altitude than said at least one selected gray water source;
an upper tank placed at a higher altitude than at least one water target connected to the system;
a pump to pump collected gray water in said lower tank to said upper tank; and
piping connecting said upper tank to said at least one water target.

2. The system of claim 1, further comprising at least one non-return valve to prevent said gray water in said upper tank from returning to said gray water in said lower tank.

3. The system of claim 1, further comprising a low pressure supply valve to connect piping from said upper tank to said at least one water target, such that water pressure in said piping and in said supply valve is substantially unchanged.

4. The system in claim 1, further comprising at least one dispenser for dispensing at least one additive into collected gray water.

5. The system in claim 1, further comprising at least one filtering mechanism selected from the group consisting of filters and traps.

6. The system of claim 5, wherein said filtering mechanism is to filter collected gray water at at least one location selected from the group consisting of: upon entering into said lower tank, upon being transferred from said lower tank to said upper tank, and upon being transferred from said upper tank to said water target.

7. The system in claim 1, further comprising at least one overflow outlet, for discharging and/or distributing excess gray water from said lower tank.

8. The system in claim 1, further comprising at least one overflow outlet for discharging and/or distributing excess gray water from said upper tank.

9. The system in claim 1, further comprising at least one drain valve for discharging excess content from said lower tank.

10. The system in claim 1, further comprising at least one drain valve for discharging excess content from said upper tank.

11. The system in claim 1, further comprising a water backup mechanism for ensuring constant flow of water into the system, said water backup mechanism including a fresh water inlet into said upper tank.

12. The system of claim 11, wherein said water backup mechanism further comprises a valve in said fresh water inlet for preventing contact between collected gray water and said fresh water inlet.

13. The system of claim 11, wherein said water backup mechanism further comprises a shut-off valve and float for determining when at least a minimum water level has been reached in said upper tank.

14. The system of claim 13, wherein said water backup mechanism is to initiate a fresh water flow into said upper tank when a selected water level has been reached in said upper tank.

15. The system of claim 14, wherein said water backup mechanism further closes off said fresh water flow when at least said minimum water level has been reached in said upper tank.

16. The system in claim 1, further comprising a shut-off valve to close off a flow of water from said upper tank to said at least one water target.

17. The system of claim 1, wherein said at least one water target is at least one target selected from the group consisting of flush tanks, gardens, fields, drainage systems, cleaning apparatus, and black water apparatus.

18. A method for recycling gray water comprising:
collecting gray water from at least one selected source in a lower tank, said lower tank being situated at an altitude lower than said at least one selected source;
transferring gray water collected in said lower tank to at least one upper tank connected to said lower tank, said upper tank connected to at least one water target, said upper tank being situated at an altitude higher than said at least one water target; and
when said water target requires a water supply, releasing gray water from said upper tank to said at least one water target.

19. The method of claim 18, further comprising dispensing at least one additive to said collected gray water.

20. The method of claim 18, further comprising discharging water from said lower tank.

21. The method of claim 18, further comprising discharging excess water from said upper tank.

22. The method of claim 18, comprising providing a filtering mechanism to filter said gray water.

23. The method of claim 22, wherein said filtering mechanism is selected from the group consisting of a filter and a trap.

24. The method of claim 18, comprising filtering out undesired elements from water collected in said lower tank, before said water is transferred into said upper tank.

25. The method of claim 18, comprising filtering out undesired elements from water in said upper tank before said water flows into said water target.

26. The method of claim 18, further comprising providing at least one additional water inlet to add fresh water to said upper tank.

27. The method of claim 26, further comprising placing a valve in said additional water inlet, to prevent contact of collected gray water in said upper tank with a fresh water source.

28. The method of claim 18, wherein said at least one water target is connected to said upper tank using piping and at least one low pressure supply valve.

29. The method of claim 28, wherein a shut-off valve is connected to said piping, to shut off said upper tank from said at least one water target.

30. A low pressure plumbing system comprising:
an inlet pipe to transfer water from a gray water collection tank into a flush tank;
a low pressure valve, with substantially similar internal thickness as said inlet pipe, said valve being connected between said inlet pipe and said flush tank; and
at least one connector, with substantially similar internal thickness as said-low pressure valve, to connect said low pressure valve to a filler tube in said flush tank.

31. A method for recycling gray water, comprising:
collecting gray water from at least one selected gray water source in a lower tank, said lower tank being situated at an altitude lower than at least one gray water source;
pumping collected gray water from said lower tank to an upper tank, said upper tank being situated at an altitude higher than at least one water target; and
when said at least one water target requires a water supply, releasing gray water from said upper tank to said at least one water target.

32. The method of claim 31, further comprising adding fresh water to said upper tank from a fresh water inlet, when gray water level in said upper tank is below a determined level.

33. The method of claim 31, wherein said at least one water source is at least one source selected from the group consisting of washing machines, basins, sinks, showers, bath tubs and air conditioning units.

34. The method of claim 31, wherein said at least one water target is at least one target selected from the group consisting of flush tanks, gardens, fields, drainage systems, cleaning apparatus, and black water apparatus.
